(19) United States
(12) Patent Application Publication
(10) Pub. No.: US 2023/0104055 A1
(43) Pub. Date: Apr. 6, 2023

(54) METHOD FOR ENRICHED TRAINING BY USING PREDICTED FEATURES OBTAINED FROM MULTIPLE MODELS

(71) Applicant: International Business Machines Corporation, Armonk, NY (US)

(72) Inventors: Simona Rabinovici-Cohen, Haifa (IL); SHAKED PEREK, Givatayim (IL); Tal Tlusty Shapiro, Zichron Yaacov (IL); EFRAT HEXTER, Beit Shemesh (IL)

(21) Appl. No.: 17/495,394

(22) Filed: Oct. 6, 2021

(51) Int. Cl. G06K 9/62; G06N 20/20

(52) U.S. Cl. CPC G06K 9/6257; G06N 20/20

(57) ABSTRACT

A system and a method for training machine learning models, using features predicted by other models, third party models, legacy models, and the like, for training dataset augmentation. Many datasets have many items with unknown, missing, or erroneous values of features. The method comprises using additional machine learning models to predict unknown features, optionally generate a distribution from their inferred score, and use a plurality of scores from the distribution and/or scores from further additional machine learning models, to create replicas for item with missing features, having different estimations of the unknown features. Followingly, train the machine learning model using data items with the known features and the scores for the unknown feature of the item.

### BACKGROUND

The present invention, in some embodiments thereof, relates to training machine learning models, and, more particularly, but not exclusively, using features predicted by other models for training dataset augmentation.

Real world data available for training may often have missing, or obviously erroneous values, imposing errors during training, or lowering the performance of many machine learning methods.

There are several methods of mitigating these problems, which are common in many domains such as biomedical, marketing, business intelligence, and the like, however naïve methods may introduce noise and impose lower precision of the model trained thereby.

Furthermore, data augmentation is known to benefit many machine learning tasks, particularly when the dataset is small. The concept of augmentations may generate additional synthetic data items which may be based on items from the dataset, and have the same ground truth inference score, however differ in properties relevant to the machine learning model.

Some known methods represent the uncertain range by its expectation value, and then process it as certain data, however this may cause valuable information loss. Some known methods may perform sampling and may provide better results than working with the expectation value alone, however don't benefit from input data that was deduced from multiple other machine learning models. Some methods may comprise building a specialized neural network for the uncertain data classification.

### SUMMARY

It is an object of the present disclosure to describe a system and a method for augmenting a dataset wherein some items comprise at least one unknown feature, and train a machine learning model therewith.

According to an aspect of some embodiments of the present invention there is provided a method of training a machine learning model comprising:

receiving a training dataset having a plurality of original items, each original item comprising a plurality of features, wherein at least one original item has at least one unknown feature;

using the plurality of features of the at least one original item on at least one additional machine learning model to generate at least one score for the at least one unknown feature of the at least one original item;

receiving an estimate of the confidence interval of the at least one score;

generating a predicted feature by applying the estimate of the confidence interval on the at least one score; and

assigning the predicted feature to the at least one unknown feature.

According to an aspect of some embodiments of the present invention there is provided a system for training a machine learning model, comprising a processing circuitry configured to:

receive a training dataset having a plurality of original items, each original item comprising a plurality of features, wherein at least one original item has at least one unknown feature;

use the plurality of features of the at least one original item on at least one additional machine learning model to generate at least one score for the at least one unknown feature of the at least one original item;

receive an estimate of the confidence interval of the at least one score;

generate a predicted feature by applying the estimate of the confidence interval on the at least one score; and

assign the predicted feature to the at least one unknown feature.

According to an aspect of some embodiments of the present invention there is provided a computer program product comprising instructions comprising instructions, wherein execution of the instructions by a processing circuitry causes the processing circuitry to:

receive a training dataset having a plurality of original items, each original item comprising a plurality of features, wherein at least one original item has at least one unknown feature;

use the plurality of features of the at least one original item on at least one additional machine learning model to generate at least one score for the at least one unknown feature of the at least one original item;

receive an estimate of the confidence interval of the at least one score;

generate a predicted feature by applying the estimate of the confidence interval on the at least one score; and

assign the predicted feature to the at least one unknown feature.

Optionally, further comprising:

generating an additional predicted feature by applying the estimate of the confidence interval on the at least one score; and

adding a synthetic item comprising substantially the plurality of features and the additional predicted feature assigned to the at least one unknown feature to the training dataset.

Optionally, applying the estimate of the confidence interval on the at least one score is generating a plurality of predicted features by sampling from a distribution based on the estimate of the confidence interval and the at least one score, and further comprising adding a plurality of synthetic items, each comprising substantially the plurality of features and a predicted feature from the plurality of predicted features, assigned to the at least one unknown feature, to the training dataset for each of the at least one original item.

Optionally, the distribution is a normal distribution whose mean is the output score of the additional machine learning model, and the standard deviation is based on the confidence interval of the at least one additional machine learning model.

Optionally, further comprising

using the plurality of features of the at least one original item on the at least one further additional machine learning model to generate at least one additional score for the at least one unknown feature of the at least one original item;

receiving an additional estimate of the confidence interval of the at least one additional score;

generating an additional predicted feature by applying a weighted averaging using the additional estimate of the confidence interval on the at least one additional score; and

adding a synthetic item comprising substantially the plurality of features and the additional predicted feature assigned to the at least one unknown feature to the training dataset.

Optionally, further comprising adjusting the predicted feature by applying domain knowledge after getting the score and confidence interval from the at least one additional machine learning model for the predicted feature, using the plurality of features.

Optionally, the weighted averaging is based on the respective area under the receiver operating characteristic curve of the at least one additional machine learning model.

Optionally, receiving an estimate of the confidence interval is selected from a group of methods consisting of: receiving the estimate of the confidence interval from the at least one additional machine learning model, an analysis of the training data and model performance, and modulating the plurality of features and applying the at least one additional machine learning model thereon.

Optionally, the at least one additional machine learning model was trained using data comprising at least partially unavailable data set.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWINGS

Some embodiments of the invention are herein described, by way of example only, with reference to the accompanying drawings and formulae. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of an exemplary system for training a machine learning model, according to some embodiments of the present invention;

FIG. 2 is a basic flow chart of a first exemplary process for training a machine learning model, according to some embodiments of the present invention;

FIG. 3 is a schematic diagram of an exemplary process training a machine learning model, according to some embodiments of the present invention;

FIG. 4 is a flow diagram of an exemplary augmentation process for training a machine learning model, according to some embodiments of the present invention;

FIG. 5 is a flow diagram of another exemplary augmentation process for training a machine learning model, according to some embodiments of the present invention; and

FIG. 6 is a flow diagram of an additional exemplary augmentation process for training a machine learning model, according to some embodiments of the present invention.

### DETAILED DESCRIPTION

The present invention, in some embodiments thereof, relates to training machine learning models, and, more particularly, but not exclusively, using features predicted by other models for training dataset augmentation.

Third party models, as well as legacy models and the like, trained on different datasets, modalities and the likes may be available, for example for predicting relapse risk from MRI and clinical data, wherein the amount of fibrous and glandular tissue on the mammogram, or the genetic status unknown, and an external density model exists.

These models may be black box models, or some of their parameters may be accessible, however they may be used to determine unknown, missing, or erroneous values of items in the dataset, based on known features of these items, with a confidence preferable to sampling from a naïve confidence interval. Some models, for example Bayesian networks, may provide a confidence prediction which may be used to estimate a confidence interval for the actual value of the unknown features.

Some embodiments may repeat the following for each item in the training data:

First, use the item input data to infer by each one of the additional machine learning models, i.e. third party, legacy, and/or the like, scores with confidence interval for that score.

Second, use each score as a normally distributed random variable and create a distribution that its expected value, μ, is the score, and the variance is computed from the confidence interval of the prediction.

Optionally use domain knowledge in creating the confidence interval for a specific item, for example, medical domain knowledge in creating the confidence interval for a property of a patient

Third, generate an ensemble of samples from different third-party, legacy and/or the like models for the unknown feature. When more than one model is available, the samples may be ensembled using a weighted average of the samples where a sample from a more accurate model, for example, a model with greater area under the curve (AUC) may be assigned a higher weight. The extent of this adjustment may vary, for example, the weight may be linear to the AUC or inversely proportional to the AUC complement (1-AUC).

And last, add a number (m) of synthetic items, each comprising a different sample assigned to the unknown feature based on the ensemble of samples for each item's respective distribution, to an augmented dataset.

Followingly, some embodiments may train the machine learning model using the known features and the ensemble of score for the unknown feature of the item, or the augmented dataset.

This method multiplies the data size by the number (m) as each item is used as input to the model a number (m) times, each with different value of the unknown feature.

Before explaining at least one embodiment of the invention in detail, it is to be understood that the invention is not necessarily limited in its application to the details of instructions and the arrangement of the components and/or methods set forth in the following description and/or illustrated in the drawings and/or the Examples. The invention is capable of other embodiments or of being practiced or carried out in various ways.

Embodiments may be a system, a method, and/or a computer program product. The computer program product may include a computer readable storage medium (or media) having computer readable program instructions thereon for causing a processor to carry out aspects of the embodiments.

The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a remote web or cloud service, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein may be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of embodiments may be assembler instructions, instruction-set-architecture (ISA) instructions, machine instructions, machine dependent instructions, microcode, firmware instructions, state-setting data, or either source code or object code written in any combination of one or more programming languages, including a scripting language such as Python or Perl, an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of embodiments.

Aspects of embodiments are described herein with reference to flowchart illustrations and/or block diagrams of methods, apparatus (systems), and computer program products according to embodiments. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

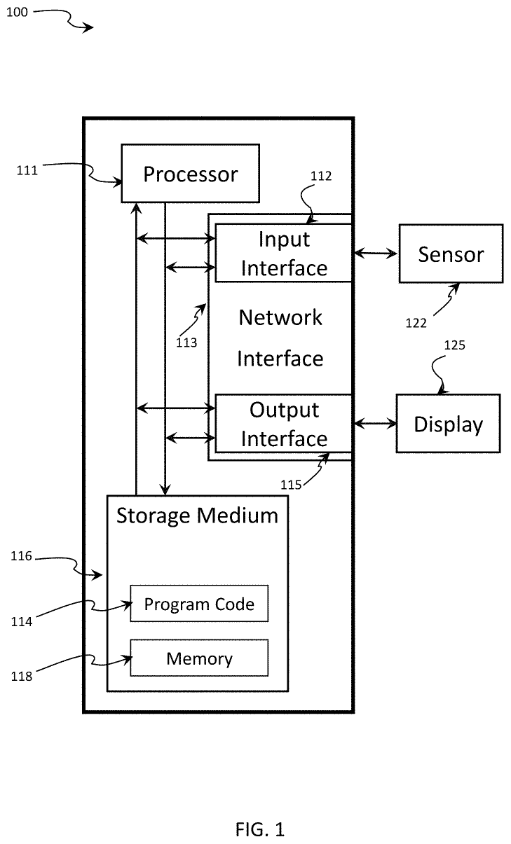

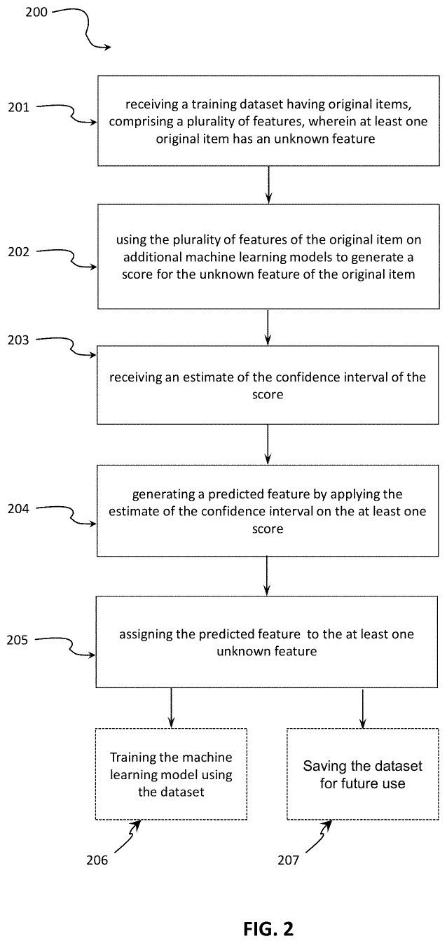

Referring now to the drawings, FIG. 1 is a schematic illustration of an exemplary system for training a machine learning model, according to some embodiments of the present invention. An exemplary training system 100 may execute processes such as 200 training a machine learning model, based on a dataset wherein some items have one or more unknown, for example missing features. Further details about these exemplary processes follow as FIG. 2 are described.

The training system 110 may include an input interface 112, an output interface 115, one or more processors 111 for executing processes such as 200, and storage 116 for storing code (program code storage 114) and/or data. The training system may be physically located on a site, implemented on a mobile device, implemented as distributed system, implemented virtually on a cloud service, on machines also used for other functions, and/or by several options. Alternatively, the system, or parts thereof, may be implemented on dedicated hardware, FPGA and/or the likes. Further alternatively, the system, or parts thereof, may be implemented on a server, a computer farm, the cloud, and/or the likes. For example, the storage 116 may comprise a local cache on the device, and some of the less frequently used data and code parts may be stored remotely.

The input interface 112, and the output interface 115 may comprise one or more wired and/or wireless network interfaces for connecting to one or more networks, for example, a local area network (LAN), a wide area network (WAN), a cellular network, the internet and/or the like. The input interface 112, and the output interface 115 may further include one or more wired and/or wireless interconnection interfaces, for example, a universal serial bus (USB) interface, a serial port, and/or the like. Furthermore, the output interface 115 may include one or more wireless interfaces for transferring data, model parameters, and/or the like, and the input interface 112, may include one or more wireless interfaces for receiving data, for example data items, from one or more devices. Additionally, the input interface 112 may include specific means for communication with one or more sensor devices 122 such as a camera, microphone, medical sensor, weather sensor and/or the like. And similarly, the output interface 115 may include specific means for communication with one or more display devices 125 such as a loudspeaker, display and/or the like.

The one or more processors 111, homogenous or heterogeneous, may include one or more processing nodes arranged for parallel processing, as clusters and/or as one or more multi core one or more processors. The storage 116 may include one or more non-transitory persistent storage devices, for example, a hard drive, a Flash array and/or the like. The storage 116 may also include one or more volatile devices, for example, a random access memory (RAM) component and/or the like. The storage 116 may further include one or more network storage resources, for example, a storage server, a network attached storage (NAS), a network drive, and/or the like accessible via one or more networks through the input interface 112, and the output interface 115.

The one or more processors 111 may execute one or more software modules such as, for example, a process, a script, an application, an agent, a utility, a tool, an operating system (OS) and/or the like each comprising a plurality of program instructions stored in a non-transitory medium within the program code 114, which may reside on the storage medium 116. For example, the one or more processors 111 may execute a process, comprising training a machine learning model, such as 200, and/or the like. This processor may generate models for various purposes such as medical diagnosis, financial decisions, property evaluations, strategical decision support, market research, and/or the like.

Reference is also made to FIG. 2 which is a basic flow chart of a first exemplary process for training a machine learning model, according to some embodiments of the present invention. The exemplary process 200 may be executed for training a system for executing one or more automatic and/or semi-automatic inference tasks, for example analytics, surveillance, video processing, voice processing, maintenance, medical monitoring and/or the like. The process 200 may be executed by the one or more processors 111.

The process 200 may start, as shown in 201 receiving a training dataset having original items, comprising a plurality of features, wherein at least one original item has an unknown feature through the input interface 112. In some examples, the plurality of original items in the dataset may be records of patients, which did not undergo all the relevant examinations. In some other examples, the records may be of apartment sales agreements, where some items lack the ceiling height or the floor.

There may be advantages for completing the unknown features using an educated estimation of the unknown features. In some cases, all the original items comprise the same plurality of features, however one feature of special interest is missing, and that feature may be particularly useful for future inferences using the machine learning model to be trained using the dataset. In other cases, the processing of evenly formatted data may be significantly simpler to implement using hardware and/or software.

The exemplary process 200 continues, as shown in 202, with using the plurality of features of the original item on additional machine learning models to generate a score for the unknown feature of the original item.

The plurality of features of the data items, particularly the at least one original item having the at least one unknown feature may be processed by one or more additional machine learning model, trained to generate score for the unknown features.

The relations of the additional machine learning models and the scores they may generate may be one to one, one to many, many to one, and many to many Therefore, the same model may generate a plurality of scores, relating to features which may or may not be missing from original items in the dataset, and some features may be predicted using scores from several of the additional machine learning models. Comparing scores relating to known features to the dataset may optionally be used to validate the model, as well as the original item features' credibility. Other models configured to generate at least one score for the at least one unknown feature of the at least one original item may also be used, however the disclosure is particularly relevant to machine learning model trained on unknown data.

The exemplary process 200 continues, as shown in 203, with receiving an estimate of the confidence interval of the score.

Some machine learning models, for example Bayesian models such as Bayesian networks (BN) may have an inherent capability to indicate the confidence, and thereby provide an estimate of the confidence interval of the at least one score.

Alternatively, an analysis based on making small modifications to the known features of the original items, the model structure, and the like, may be used provide the confidence interval.

The exemplary process 200 continues, as shown in 204, with generating a predicted feature by applying the estimate of the confidence interval on the at least one score.

The predicted feature may be the score generated by the machine learning model, however, particularly when augmenting the dataset by generating additional synthetic items, other values from the confidence interval.

Generating a predicted feature by applying the estimate of the confidence interval on the at least one score may also be obtained by using the score in some probability, or sampling from a distribution, for example an even distribution, a Gaussian, distribution, a gamma distribution, and/or the like, on the confidence interval, in some other probability.

And subsequently, as shown in 205, the process 200 may continue by assigning the predicted feature to the at least one unknown feature.

The assigning of the predicted feature may be targeted at the at least one unknown feature of the original item, to an additional, synthetic item, generated of augmentation and having features based on the known feature of the original item.

Optionally followingly, as shown in 206 the process 200 may continue by training the machine learning model using the dataset. Followingly, the system may be used for inferencing on items received for example through the input interface 112, and the inferences, as well as the model, may be exported through the output interface 115 shown in FIG. 1.

Optionally, alternatively, or additionally, as shown in 207 the process 200 may continue by saving the dataset for future use, by the same system, for example in the memory 118, or by transferring it to external storage or a different system, using the output interface 115 shown in FIG. 1.

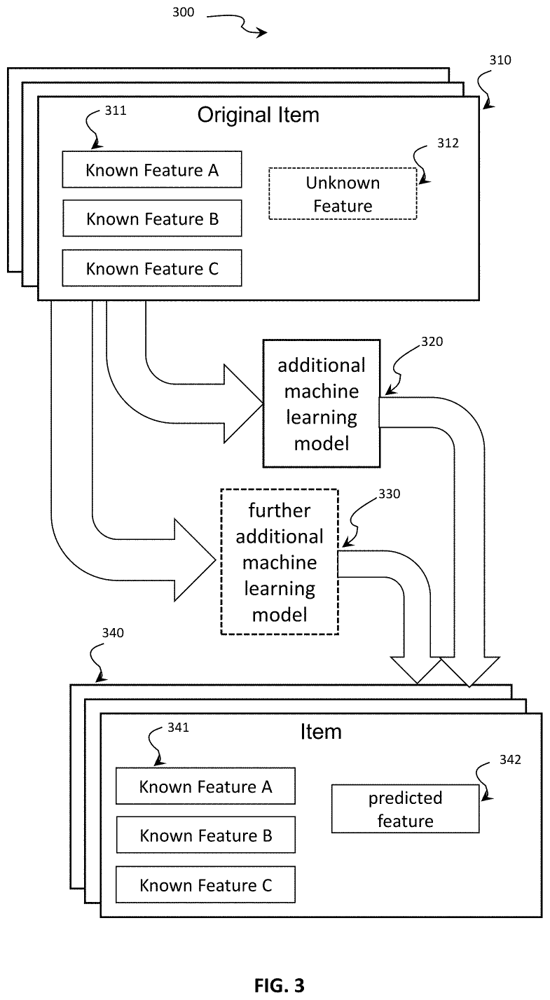

Reference is also made to FIG. 3, which is a schematic diagram of an exemplary process training a machine learning model, according to some embodiments of the present invention.

The diagram 300 depicts the basic dataflow of an augmentation method for training a machine learning model, using additional machine learning models.

The disclosed method may be used in many circumstances, however it is more valuable when the additional machine learning models are black box, third party, legacy, or were trained using data comprising at least partially unavailable data set.

The original item, shown in 310, from the dataset has a set of known features shown in 311. The features may be for example the blood pressure, quantity of some substances in the blood, the person's feet length, and/or the like. Alternatively the features may be the car's manufacturing date, type, mileage, last maintenance date, and/or the like. Further alternatively, known features may comprise the weather, number of buyers, properties of a store location, and/or the like. An unknown feature may be a feature one or more existing machine learning models were trained to predict from the known features, for example heart rate, car safety, salesperson workload, and/or the like.

The item may be fed to the at least one additional machine learning model, i.e. the additional machine learning model shown in 320, and optionally one or more further additional machine learning model shown in 330.

The item shown in 340 may be the original item, or a synthetic item, replicated from the original item with or without modifications to the known features shown in 341. The predicted feature, shown in 342 and assigned to the at least one unknown feature may be the score inferred by one of the additional machine learning models shown in 320 and 330. Alternatively a weighted averaging of the scores from 320 and 330, wherein the weight may be determined by the model credibility and reliability, confidence indication generated by the model, domain knowledge, and/or the like. Furthermore some modulation to the score may be applied, optionally with accordance to a confidence interval of the score, for example by sampling from a distribution based thereupon. Optionally more than one predicted feature may be assigned to the item. Note that alternative data flows are apparent to the person skilled in the art and are within the scope of the claims.

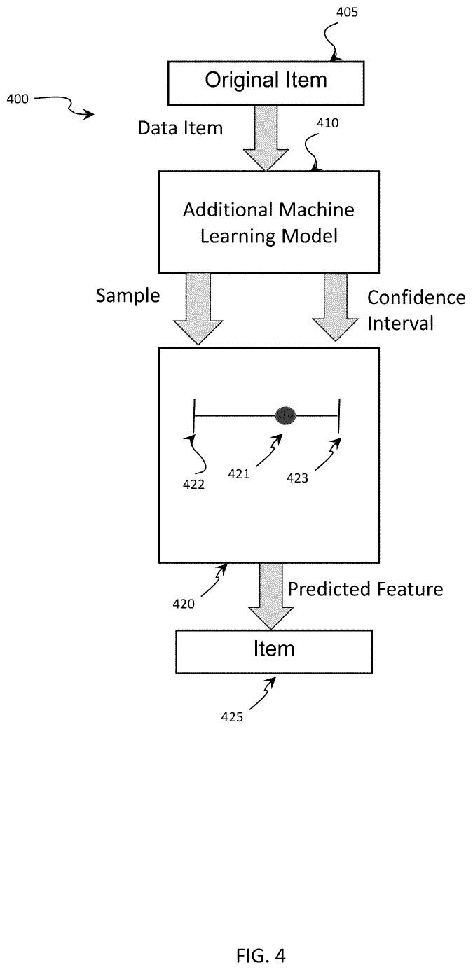

Reference is also made to FIG. 4, which is a flow diagram of an exemplary augmentation process for training a machine learning model, according to some embodiments of the present invention.

The flow diagram 400 shows a process starting with and original item, shown in 405, from the dataset, having at least one unknown feature. The feature may have a null value, represented by zero, infinity, an obviously non-reasonable value, or the like. The process may be augmented or repeated for a plurality of unknown features, and may also be applied on random known features for augmentation of the training dataset. The item may be received from the memory or the input interface, shown in 118 and 112 respectively on FIG. 1.

The original item may be processed as a data item by an additional machine learning model, shown in 410, i.e. not the machine learning model intended to be trained, which may be a black box model, a third party model, a legacy model, an in house model developed for other purposes or the like. Further additional machine learning models may also be used.

Some machine learning models, for example Bayesian networks, may provide together with the score shown in 421, as inferred, a confidence indication, such as an estimate of the confidence in the score correctness and precision, and/or a confidence interval. When the additional machine learning model does not have an inherently generated confidence indication, analytic methods, knowledge of the model training data extent and methods, differential analysis or input modulation may be used to estimate the confidence interval, shown from 422 to 423. When a plurality of additional machine learning models is used, the confidence interval may be determined by a union, intersection, majority, or the like.

The predicted feature, assigned to the item shown in 425 may be the score or another value form the confidence interval. The item may be the original item, a replica thereof, or a synthetic item added to enrich the dataset through the augmentation, using an access to the memory 118, or the output interface 115 shown in FIG. 1.

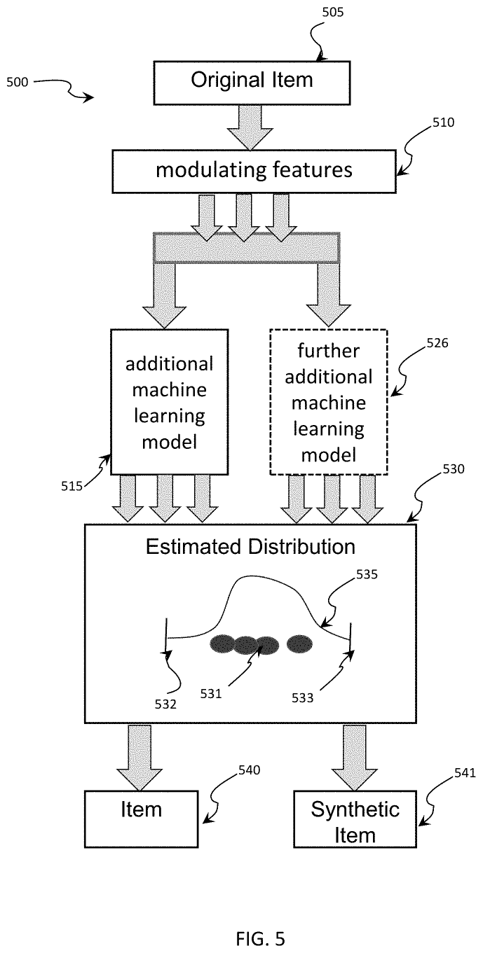

Reference is also made to FIG. 5, which is a flow diagram of another exemplary augmentation process for training a machine learning model, according to some embodiments of the present invention.

The flow diagram 500 shows a process starting with an original item, shown in 505, from the dataset, having at least one unknown feature. The item may be received from the memory or the input interface, shown in 118 and 112 respectively on FIG. 1.

Preferred implementations of the disclosure may determine the weight that should be assigned to their inference, a confidence interval, and/or the like. For example, the weighted averaging may be based on the respective area under the receiver operating characteristic curve of each of the additional machine learning models.

Receiving an estimate of the confidence interval may be obtained by several methods: receiving the estimate of the confidence interval from one or more of the additional machine learning models, an analysis of the training data and model performance, and modulating the plurality of features and applying the at least one additional machine learning model thereon.

Some machine learning models lack an inherent, or otherwise straightforward method to generate a confidence indication, which may be converted to a confidence interval.

Some models may be presented in a form which enables use of analytic methods to estimate the confidence interval. In some other cases, domain knowledge may help estimating the confidence interval.

A confidence indication may also be generated by slight changes on the inputs of that machine learning model, for example by modulating features shown in 510. The modulation may be obtained by preset or randomized changes on the known features of the original items, or the inputs of the modulating features, for example by 0.1%, 1% or 5% up and down, and checking if and how far the inference changes.

The modulated features may be fed to the additional machine learning model shown in 525, and optionally the further additional machine learning model shown in 526. Note that the additional machine learning models are not he machine learning model intended to be trained, and may be black box models, third party models, legacy models, and other models, which may be characterized by being trained with data which can't be accessed for training the machine learning model.

Followingly, the disclosed method may comprise generating an estimated distribution. The distribution shape may be a Gaussian wherein the mean is substantially the mean of the scores generated by the additional machine learning model, and the standard deviation is based on the standard deviation of the scores, and thus the distribution is a normal distribution whose mean is the output score of the additional machine learning model, and the standard deviation is based on the confidence interval of the at least one additional machine learning model.

Alternatively, other distributions such as exponential, gamma, beta, and the like may be used. The illustrated distribution shown in 535 is an exemplary distribution based on the scores shown in 531, and a confidence interval shown from 532 to 533.

As shown, applying the estimate of the confidence interval on the at least one score may comprise generating a plurality of predicted features by sampling from a distribution based on the estimate of the confidence interval and the at least one score.

A sample from the estimated distribution may be assigned to the unknown feature, or one of the unknown features, of the item shown in 540.

Additionally, a plurality of synthetic items, shown in 541, each comprising substantially the plurality of features and a predicted feature from the plurality of predicted features, assigned to the at least one unknown feature, may be added to the training dataset for some, or each of the original items. This is also an example of generating an additional predicted feature by applying the estimate of the confidence interval on the at least one score.

The flow may be followed by adding the item and the synthetic item, comprising substantially the plurality of features and the additional predicted feature assigned to the at least one unknown feature, to the training dataset.

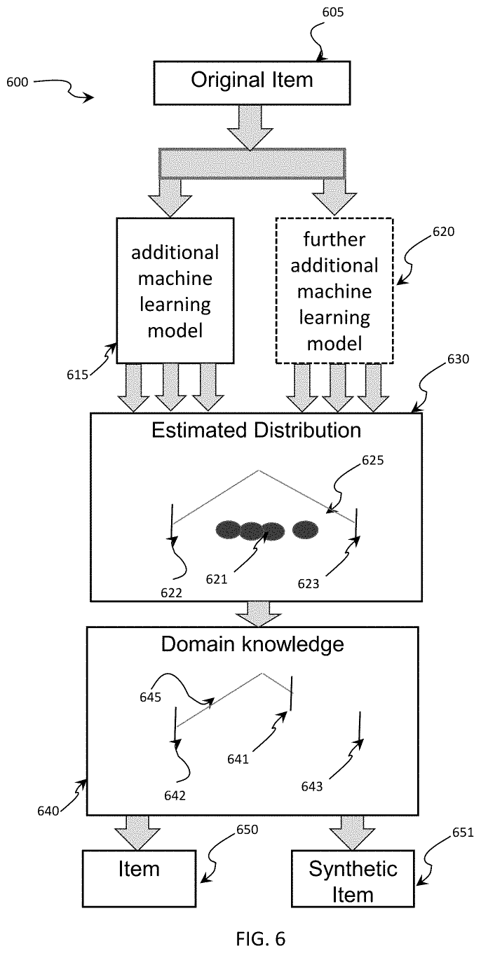

Reference is also made to FIG. 6, which is a flow diagram of an additional exemplary augmentation process for training a machine learning model, according to some embodiments of the present invention.

The flow diagram 600 shows a process starting with and original item, shown in 605, from the dataset, having at least one unknown feature. The item may be received from the memory or the input interface, shown in 118 and 112 respectively on FIG. 1.

The original item is processed as a data item by an additional machine learning model, shown in 615, and optionally a further additional machine learning model shown in 526. These models differ from the machine learning model intended to be trained, and more than one further additional machine learning models may be used. Receiving an additional estimate of the confidence interval of the at least one additional score may be obtained by receiving the estimate of the confidence interval from the at least one additional machine learning model, an analysis of the training data and model performance, or modulating the plurality of features and applying the at least one additional machine learning model thereon.

Followingly, the disclosed method may comprise generating an estimated distribution. The distribution shape may be a Gaussian, however other distributions such as even, gamma, beta, and the like may be used. The distribution may be an optionally weighted superposition of distributions, estimated for each of the additional machine learning models shown in 615 and 620. Alternatively, an intersection, a union, or a majority decision may be applied on the distribution.

The illustrated distribution shown in 625 is an exemplary distribution based on the scores shown in 621 and/or the confidence intervals, and a confidence interval shown from 622 to 623.

In some examples, the predicted feature may be adjusted by applying domain knowledge after getting the score and confidence interval from the at least one additional machine learning model for the predicted feature, using the plurality of features.

For example, it may be known that in a certain city, an ordinance regulating the ceiling height of an apartment to be between 2.5 m to 2.8 m have been held between the years 1970 and 1990. Therefore, given that an apartment was built and on that city at the time, and the ratio between its value and its area, and other factors from the known features, indicate the ceiling height ranges from 2.6 m to 3.2 m, the predicted features may be limited to the range of 2.6 m to 2.8 m.

Similarly, if a patient has a syndrome known to cause high blood pressure in nearly certain probability, and the known features indicate a systolic blood pressure of 120 to 160 mm mercury, the range may be limited, for example from 140 to 160.

The exemplary illustrated distribution after applying the domain knowledge is shown in 645 and ranging from 642 to 641 rather than 643, as the range from 643 to 641 may be disregarded due to domain knowledge.

Followingly, a sample from the distribution shown in 645 may be assigned to the associated missing feature of the item shown in 650.

This is an example of using the plurality of known features of the at least one original item on the additional machine learning model and the further additional machine learning model to generate at least one additional score for the at least one unknown feature of the at least one original item.

Similarly, an additional sample from the distribution shown in 645 may be generated, and assigned to the associated missing feature of a synthetic item shown in 651, thereby adding a synthetic item comprising substantially the plurality of features and the additional predicted feature assigned to the at least one unknown feature to the training dataset.

The distribution characteristics may also be modulated, for example by modulating weights between models when generating different samples for the predicted features. This may be an example of generating an additional predicted feature by applying a weighted averaging using the additional estimate of the confidence interval on the at least one additional score. Note that alternative flows are apparent to the person skilled in the art and are within the scope of the claims.

It is expected that during the life of a patent maturing from this application many relevant machine learning methods will be developed and the scope of the term machine learning model is intended to include all such new technologies a priori.

As used herein the terms “about” or “substantially” refer to functionally equivalent, which may range from ±20% to ±0.1% according to the domain, and may include other modifications in non-numerical context.

The terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise. For example, the term “a component” or “at least one component” may include a plurality of components, including mixtures thereof.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicants that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority documents of this application is/are hereby incorporated herein by reference in its/their entirety.

What is claimed is:

1. A method of training a machine learning model comprising:
receiving a training dataset having a plurality of original items, each original item comprising a plurality of features, wherein at least one original item has at least one unknown feature;
using the plurality of features of the at least one original item on at least one additional machine learning model to generate at least one score for the at least one unknown feature of the at least one original item;
receiving an estimate of the confidence interval of the at least one score;
generating a predicted feature by applying the estimate of the confidence interval on the at least one score; and
assigning the predicted feature to the at least one unknown feature.

2. The method of claim 1, further comprising:
generating an additional predicted feature by applying the estimate of the confidence interval on the at least one score; and
adding a synthetic item comprising substantially the plurality of features and the additional predicted feature assigned to the at least one unknown feature to the training dataset.

3. The method of claim 2, wherein applying the estimate of the confidence interval on the at least one score is generating a plurality of predicted features by sampling from a distribution based on the estimate of the confidence interval and the at least one score, and further comprising adding a plurality of synthetic items, each comprising substantially the plurality of features and a predicted feature from the plurality of predicted features, assigned to the at least one unknown feature, to the training dataset for each of the at least one original item.

4. The method of claim 3, wherein the distribution is a normal distribution whose mean is the output score of the additional machine learning model, and the standard deviation is based on the confidence interval of the at least one additional machine learning model.

5. The method of claim 1, further comprising
using the plurality of features of the at least one original item on the at least one further additional machine learning model to generate at least one additional score for the at least one unknown feature of the at least one original item;
receiving an additional estimate of the confidence interval of the at least one additional score;
generating an additional predicted feature by applying a weighted averaging using the additional estimate of the confidence interval on the at least one additional score; and
adding a synthetic item comprising substantially the plurality of features and the additional predicted feature assigned to the at least one unknown feature to the training dataset.

6. The method of claim 1, further comprising adjusting the predicted feature by applying domain knowledge after getting the score and confidence interval from the at least one additional machine learning model for the predicted feature, using the plurality of features.

7. The method of claim 5, wherein the weighted averaging is based on the respective area under the receiver operating characteristic curve of the at least one additional machine learning model.

8. The method of claim 1, wherein receiving an estimate of the confidence interval is selected from a group of methods consisting of: receiving the estimate of the confidence interval from the at least one additional machine learning model, an analysis of the training data and model performance, and modulating the plurality of features and applying the at least one additional machine learning model thereon.

9. The method of claim 1, wherein the at least one additional machine learning model was trained using data comprising at least partially unavailable data set.

10. A system for training a machine learning model, comprising a processing circuitry configured to:
receive a training dataset having a plurality of original items, each original item comprising a plurality of features, wherein at least one original item has at least one unknown feature;
use the plurality of features of the at least one original item on at least one additional machine learning model to generate at least one score for the at least one unknown feature of the at least one original item;
receive an estimate of the confidence interval of the at least one score;
generate a predicted feature by applying the estimate of the confidence interval on the at least one score; and
assign the predicted feature to the at least one unknown feature.

11. The system of claim 10, wherein the processing circuitry is further configured to:
generate an additional predicted feature by applying the estimate of the confidence interval on the at least one score; and
add a synthetic item comprising substantially the plurality of features and the additional predicted feature assigned to the at least one unknown feature of the training dataset.

12. The system of claim 11, wherein applying the estimate of the confidence interval on the at least one score is generating a plurality of predicted features by sampling from a distribution based on the estimate of the confidence interval and the at least one score, and the processing circuitry is further configured to execute for each of the at least one original item:
generating a plurality of additional predicted features by sampling from a distribution based on the estimate of the confidence interval; and
adding a plurality of synthetic items, each comprising substantially the plurality of features and a predicted feature from the plurality of predicted features, assigned to the at least one unknown feature, to the training dataset.

13. The system of claim 12, wherein the distribution is a normal distribution whose mean is the output score of the additional machine learning model, and the standard deviation is based on the confidence interval of the at least one additional machine learning model.

14. The system of claim 10, wherein the processing circuitry is further configured to:
use the plurality of features of the at least one original item on the at least one further additional machine learning model to generate at least one additional score for the at least one unknown feature of the at least one original item;
receive an additional estimate of the confidence interval of the at least one additional score;
generate an additional predicted feature by applying a weighted averaging using the additional estimate of the confidence interval on the at least one additional score; and
add a synthetic item comprising substantially the plurality of features and the additional predicted feature assigned to the at least one unknown feature to the training dataset.

15. The system of claim 10, further comprising adjusting the predicted feature by applying domain knowledge after getting the score and confidence interval from the at least one additional machine learning model for the predicted feature, using the plurality of features.

16. The system of claim 14, wherein the weighted averaging is based on the respective area under the receiver operating characteristic curve of the at least one additional machine learning model.

17. The system of claim 10, wherein receiving an estimate of the confidence interval is selected from a group of methods consisting of: receiving the estimate of the confidence interval from the at least one additional machine learning model, an analysis of the training data and model performance, and modulating the plurality of features and applying the at least one additional machine learning model thereon.

18. The system of claim 10, wherein the at least one additional machine learning model was trained using data comprising at least partially unavailable data set.

19. A computer program product comprising instructions, wherein execution of the instructions by a processing circuitry causes the processing circuitry to:
receive a training dataset having a plurality of original items, each original item comprising a plurality of features, wherein at least one original item has at least one unknown feature;
use the plurality of features of the at least one original item on at least one additional machine learning model to generate at least one score for the at least one unknown feature of the at least one original item;
receive an estimate of the confidence interval of the at least one score;
generate a predicted feature by applying the estimate of the confidence interval on the at least one score; and
assign the predicted feature to the at least one unknown feature.
